(19) United States
(12) Patent Application Publication
(10) Pub. No.: US 2011/0005783 A1
(43) Pub. Date: Jan. 13, 2011

(54) AERATOR MECHANISM WITH VERTICALLY RECIPROCATING TINE

(75) Inventor: David John Livingstone, New South Wales (AU)

Correspondence Address: SNELL & WILMER LLP (OC), 600 ANTON BOULEVARD, SUITE 1400, COSTA MESA, CA, 92626, US

(73) Assignee: GREENCARE INDUSTRIES PTY LTD, BLAXLANDS RIDGE, NSW (AU)

(21) Appl. No.: 12/528,262

(22) PCT Filed: Feb. 20, 2008
(86) PCT No.: PCT/AU08/00230

§ 371 Date: Sep. 15, 2010

(30) Foreign Application Priority Data
Feb. 22, 2007 (AU) 2007900914

(51) Int. Cl. A01B 79/00; A01B 45/02

(52) U.S. Cl. 172/1; 172/21

(57) ABSTRACT

A turf aerator (11) provided with a reciprocating drive mechanism (33, 37) to repeatedly drive a leg (35) carrying a tine (31) vertically into the ground (52) and retract it again at regularly spaced intervals, the tine leg (35) being substantially rigid and pivotally mounted at its upper end (36) to a drive assembly (33). The tine leg (35) is provided with a cam surface (160) in the forward direction and a forward guide arrangement (141) including a forward travel limiting stop, acting on the cam (160), to limit forward travel of the tine leg (35) and thereby maintain a substantially vertical travel path for the leg (35).

### INTRODUCTION

The present invention relates generally to green keeping equipment and in particular the invention provides an improved reciprocating drive for a turf aeration device.

### BACKGROUND OF THE INVENTION

It is well known that in the cultivation of turf surfaces aeration of the root system is required from time to time to relieve compaction and enable penetration of nutrients beneath the surface mat of the turf. A variety of mechanisms have been used in the past to achieve this end, all of which generally include tines carried in some type of mechanism that allows periodic spiking of the surface. These mechanisms have increased in sophistication over the years from simple tine rollers comprising a drum with a plurality of tines located pointing radially outwardly from its surface to elaborate reciprocating mechanisms.

A basic problem with tine rollers and, which has been overcome to a certain degree by some more advanced systems is that of tearing which occurs when the tine does not enter and exit the turf vertically but instead passes through an arc while it is in the ground. This action damages the turf surface and makes it less useful for its intended purpose during the period immediately following aeration. It is also highly desirable that turf aerators be able to operate quickly in order to minimise the cost of this operation and enable the operation to be performed more regularly.

It is also desirable that the reciprocating mechanism can be removed from ground engagement while operating at speed without the tines becoming unstable in their motion. Operating prior art machines in this way generally leads to flailing behaviour and can have detrimental effects. Being able to operate the mechanism at speed while disengaged from the ground allows the operator to lift the mechanism while passing over small obstructions such as cups on putting greens and tee markers on tee-off areas, pop-up sprinkler heads, etc, without having to stop or slow the mechanism. It also allows the mechanism to be brought up to operating speed before dropping the tines into ground engagement at start-up and lessens the chance of accidentally moving forward with the tines engaged in the ground and the reciprocating mechanism not operating (which will lead to tine leg damage).

### SUMMARY OF THE INVENTION

The present invention provides a turf aerator with a reciprocating drive mechanism comprising:

a substantially rigid tine leg pivotally mounted at an upper end to a drive assembly arranged to reciprocate the tine leg along its longitudinal axis and the tine leg being provided with a cam surface facing the direction in which the aerator travels when in use,

the drive assembly comprising:
a reciprocating drive member to which the tine leg is pivotally attached at a first point along the drive member, the drive member being pivotally connected at a second point to a frame and at a third point to a first eccentric, the first eccentric being rotated to reciprocate the first point on the drive member substantially vertically; and
a forward guide arrangement comprising:
a forward travel-limiting stop acting on the cam surface of the tine leg to limit forward travel of the tine leg when the tine is out of the ground, the cam surface being shaped to compensate for arcuate motion of the first point of the drive member to thereby maintain a substantially straight and axial path of travel of the tine while the tine leg is running against the forward travel-limiting stop.

The present invention also provides method of reciprocating a tine in a turf aerator comprising:

providing a substantially rigid tine leg carrying a substantially axially mounted tine at one end, and a cam surface on the tine leg facing the direction in which the aerator travels when in use:

driving the tine leg along its longitudinal axis the tine leg being pivotally mounted, at an end opposite the tine, to a drive assembly arranged to reciprocate the tine leg;

biasing the tine leg towards a forward travel-limiting stop acting on the cam surface of the tine leg to limit forward travel of the tine leg when the tine is out of the ground, the cam surface being shaped to compensate for arcuate motion of the pivotably connected end of the tine leg to thereby maintain a substantially straight and axial path of travel of the tine while the tine leg is running against the forward travel-limiting stop.

The cam surface preferably has a shape which is a function of an arc of travel of the first point of the drive member.

The forward travel-limiting stop may comprise a roller mounted on a spring arm and located forward of the tine leg relative to the normal direction of travel of the aerator to define a forward limit of travel of the tine leg. The spring arm will preferably be semi-rigid as a result of having a high spring rate. In the case where a relatively large diameter roller is used, the shape of the cam surface may be adjusted to allow for the change in point of contact between the cam surface and the forward travel-limiting stop roller over the length of reciprocation of the tine leg

The third point of the reciprocating drive member is preferably located intermediate the first and second points, however this is not essential and, it will be appreciated that the third point can be located in various positions relative to the first and second points.

The lower end of the tine leg is able to move in a rearward direction to allow the tine to move relative to the machine while the tine is in the ground. The tine leg is biased to a forward position such that when the tine leaves the ground, the tine leg returns toward the forward end of its travel ready for re-engagement with the ground. Forward biasing of the tine leg is preferably achieved by a rear guide mechanism including a rear-guide roller mounted on a pivotable arm, located rearward of the tine leg relative to the normal direction of travel of the aerator and biased to a forward position. Biasing force may be by a variety of spring arrangements. By acting on a variable point on the tine leg the roller exerts a variable return torque in the forward direction, the torque increasing to a maximum as the tine leg reaches the top of its stroke.

The rear-guide roller and the forward travel-limiting stop roller may engage a lower portion of the tine leg whereby the rear-guide roller biases the tine leg towards a position ready for insertion of the tine into the ground and the forward travel-limiting stop roller limits travel of the tine leg in the forward direction.

The biasing may also be effected by way of a resiliently flexibly mounted guide arrangement. The guide arrangement may comprise a roller mounted at the rear of the tine leg. The roller may be rotatably mounted at the end of a roller arm, and a plurality of coil springs may be connected to the roller and/or its arm for drawing the roller into abutment with the tine leg and for exerting a restoring force on the tine leg.

This guide arrangement may also serve to damp rapid horizontal reciprocatory motion of the tine leg when the aerator is rapidly traversing a surface, in use.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF THE DRAWINGS

Embodiments of a turf aerator will now be described by way of example with reference to the accompanying drawings in which:

FIG. 1 illustrates a perspective view of a first embodiment of the a turf aerator comprising an aerator arranged to be carried by, or towed behind a vehicle provided with a three point hitch;

FIG. 2 is a side elevation of the aerator mechanism at its lowest point in a cycle of operation;

FIGS. 3 (a), (b) and (c) are a series of diagrams showing the motion of a tine leg in a prior art turf aerator;

FIGS. 4 (a), (b) and (c) are a series of diagrams showing the motion of a tine leg in the present turf aerator by way of comparison with the diagrams of FIG. 3;

FIG. 5 illustrates a perspective view of a second embodiment of the a turf aerator comprising a self-propelled turf aerator;

FIG. 6 illustrates a perspective view of a “ride on” embodiment of a turf aerator;

FIG. 7 illustrates a side view of the guide mechanism as shown in FIG. 2; and

FIG. 8 illustrates a side elevation of the foot mechanism as shown in FIG. 2.

### Detailed Description of a Turf Aerator

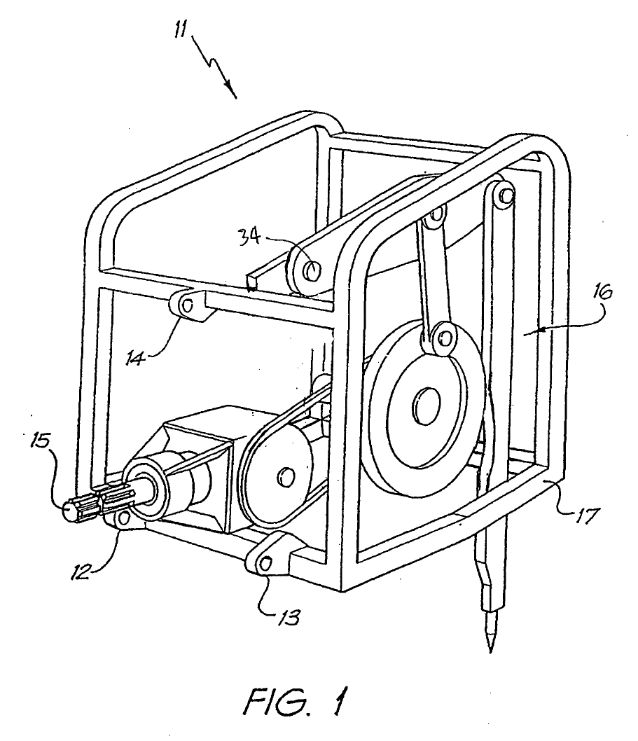

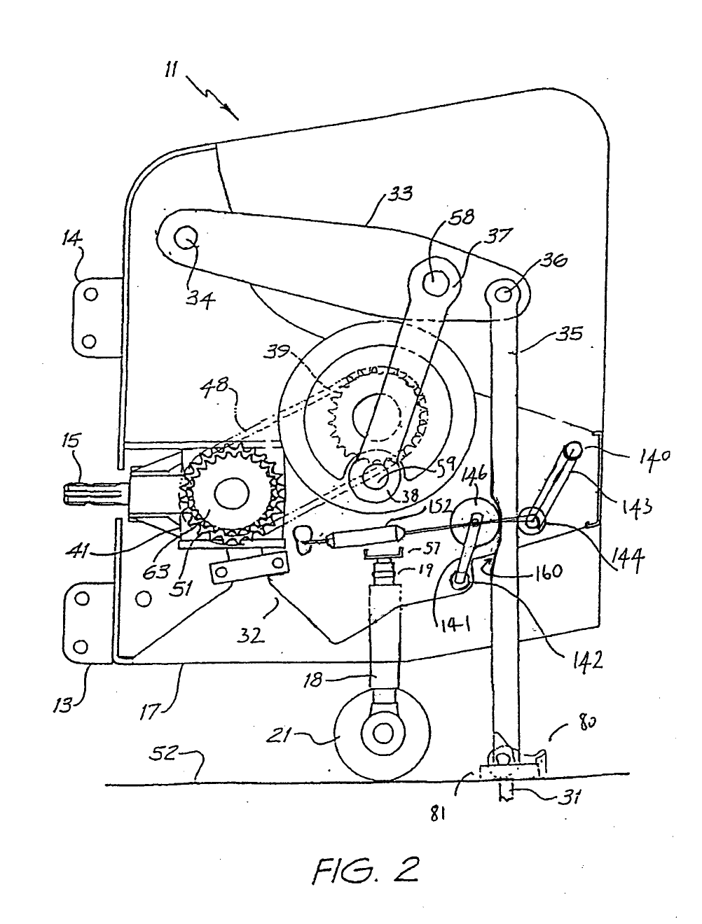

Referring to FIG. 1, a first implementation of the turf aerator is illustrated in which an aerator 11 of the type towed behind a tractor or similar vehicle is shown. In this embodiment, mounting points 12, 13, 14 are provided for attachment to the three-point hitch of the towing vehicle and an input shaft 15 is arranged to connect to a power take-off of the towing vehicle. The aerator mechanism 16 is mounted on a chassis 17 and the rear wheels 21 (see FIG. 2) are mounted on a ram 18, extending below a bracket 57 on the chassis 17 and connected by resilient connection 19, such that when the towing vehicle raises the three point hitch, the chassis 17 raises but the wheels or a roller 21 connected to the ram 18 may be lowered to remain in contact with the ground to help support the aerator and to vary the tine penetration depth.

Referring to FIG. 2, an embodiment of the turf aerator is illustrated wherein the aerator mechanism is shown in detail at a point of its cycle where the aerator tines 31 are fully lowered into the turf surface 52. The mechanism is mounted on a frame 32 extending above the chassis 17 and includes a substantially horizontally extending reciprocating drive member 33 mounted to the frame 32 by a pivotal connection 34, and a substantially vertical tine leg 35 connected at its upper end to the opposite end of the drive member 33 by a pivotal connection 36. The tines 31 are mounted to a platform that forms part of the foot assembly 80 which is mounted to the lower end of the tine leg 35. A push rod 37 extends between a pivotable connection 58 on the drive member 33 and the pivotable connection 59 on a crank 38 to drive the drive member 33 and thereby the tine leg 35 in reciprocating motion. The crank 38 is connected to a coaxial chain wheel 39 which is driven via chains 48, chain wheel 51 and gearbox 41 and power take-off connection 15. An adjustable tensioning means may be provided (not shown) to regulate the movement of the chains 48.

Rotation of the crank 38 causes reciprocation of the drive member 33 via the push rod 37 and subsequently this causes the tine leg 35 to reciprocate substantially vertically. Reciprocation is controlled in synchronisation with forward motion of the aerator such that a uniform pattern of holes is punched in the turf surface 52 as the aerator advances. As the aerator mechanism moves forward with the tines 31 inserted in the ground, the tines moves backward relative to the implement.

After the tines 31 are retracted from the ground, the tine leg 35 is moved forward by a rear-guide mechanism comprising a rear-guide roller 144 carried on an arm 143 mounted to the frame at a pivot point 140 and biased to a forward position by a spring 152. The rear-guide mechanism is located behind the tine leg 35, and acts to push the tine leg 35 forward when it leaves the ground 52 and to continuously and smoothly push it towards the forward extremity of its travel. The rear-guide roller 144 pushes the tine leg 35 forward until the tine leg 35 strikes the front-guide mechanism, which limits forward travel of the tine leg 35 prior to the tines 31 being reinserted into the turf surface 52.

The forward guide mechanism includes a spring arm 141 extending from an attachment point 142 on the frame 32. A forward travel-limiting stop roller 146 is attached to a distal end of the spring arm 141 and abuts the tine leg 35 at least when the tine leg reaches its forward most position. The spring arm 141 is preferably formed as a yoke cut from flat spring steel and the front travel-limiting roller 146 is carried on an axel traversing the open end of the yoke.

Referring to FIGS. 1, 2, 4, 5 & 6, the tine leg 37 is provided with a cam surface 160 over part of its forward facing surface. When the tine leg is out of ground engagement and is limited in its forward travel by the forward travel limiting stop roller 146, the cam surface 160 engages with the roller 146 during part of the reciprocating motion of the tine leg. This is particularly the case when the aerator mechanism is raised out of ground engagement and the tine leg is biased to run in continuous engagement with the forward travel-limiting stop roller 146. The cam surface 160 has a shape which is complimentary to the path of the pivot point 36 at the upper end of the tine leg (or at least the part of that path from the location at which the pivot point 36 is furthest rearward, relative to the forward direction of travel, to the point at the lower extremity of travel of the pivot point 36), such that as the pivot point 36 passes through the lower portion of its path, the cam 160 compensates for the tendency of the tine 31 to kick in a rearward direction.

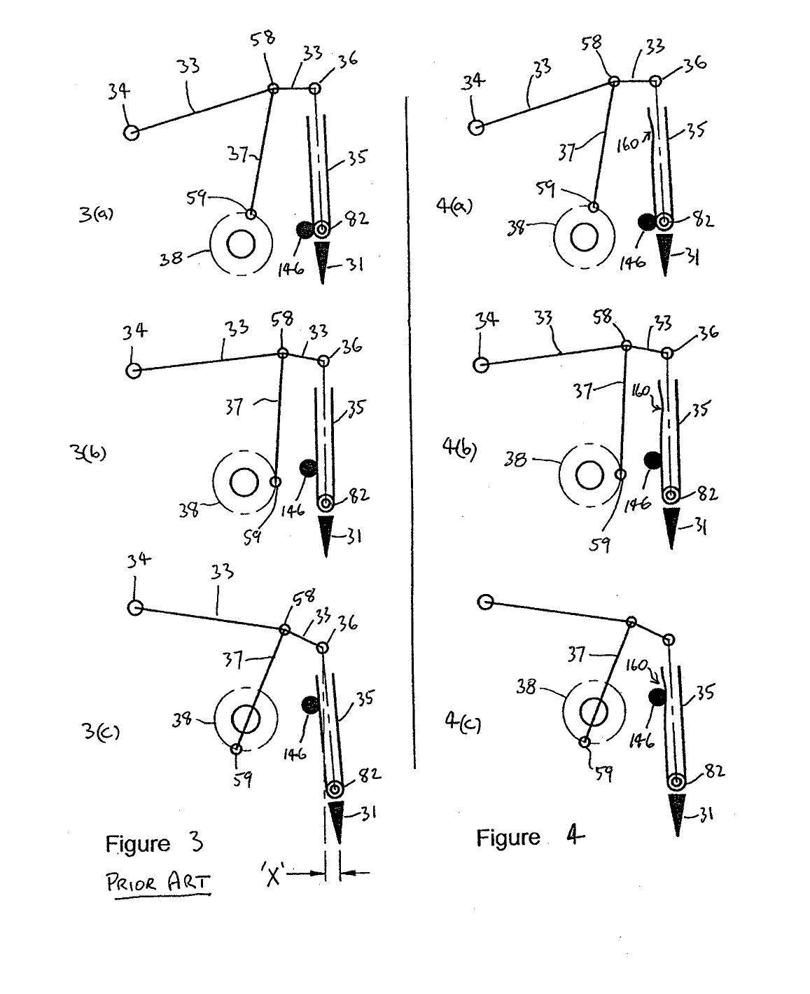

Referring to FIG. 3, which shows a prior art arrangement, it will be noted that as the reciprocating drive member 33 moves downward from the position shown in FIG. 3(a) through the position shown in FIG. 3(b) to the position shown in FIG. 3(c) essentially representing the lowest point in the travel of the reciprocating drive member and its associated pivot point 36, the tine moves by a distance ‘X’ to the right (or rearward relative to the direction of motion of the mechanism). This kicking leads to flailing motion and excessive vibration when the tines are not engaged in the ground. It also leads to surface damage (i.e. tearing) as the tines are inserted into the ground with the mechanism running and produces rocking of the tines in the hole if the mechanism is run while engaging the ground without forward motion. In the worst case this could lead to tine leg damage.

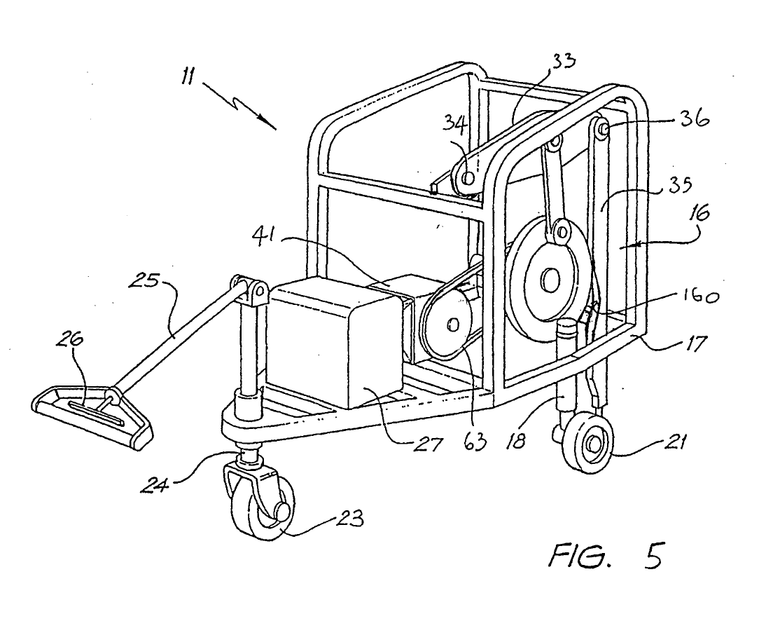

By comparison, referring to FIG. 4, during the same part of the reciprocation cycle, as seen in FIG. 3, the cam surface 160 in FIG. 4 allows the path of travel of the tine 31 to remain substantially vertical relative to the frame of reference of the chassis (which may be in motion) while the tine leg 35 is running against the forward travel limiting stop roller 146. This reduces flailing and vibration compared to the prior art arrangement (everything else being equal) making it feasible to insert and/or remove the reciprocating mechanism from ground engagement while operating at speed without the tines becoming unstable in their motion. Being able to operate the mechanism at speed while disengaged from the ground allows the operator to lift the mechanism while passing over small obstructions such as cups on putting greens and tee markers on tee-off areas, pop-up sprinkler heads, etc, without having to stop or slow the mechanism. It also allows the mechanism to be brought up to operating speed before dropping the tines into ground engagement at start-up and lessens the chance of accidentally moving forward with the tines engaged in the ground and the reciprocating mechanism not operating (which will lead to tine leg damage).

Because the guide mechanisms, and in particular the rear guide mechanism, operate at variable points on the tine leg, depending upon the point of the operating cycle, the torque applied to move the leg forward as it is removed from the ground increases towards maximum at the top of its stroke. This results in a smooth increase in acceleration as the tine is lifted.

When the aerator 11 is set at its normal operating height, the wheels or roller 21 will be in contact with the ground 52 to help support the aerator (or in self-propelled models, to substantially fully support the aerator). When aeration is not in progress, the jack 18 is extended to raise the chassis 17 sufficiently to lift all of the tines clear of the ground, regardless of their position in the aeration cycle. In the case of the tractor-mounted model of FIGS. 1 & 2, this would be carried out in conjunction with the raising of the 3-point hitch, connected to the mounting points 12, 13 14. The jack 18 additionally serves as a tine insertion depth adjustment mechanism.

It should be noted that while one tine leg 35 is illustrated for the sake of simplicity, typically 2, 4, or more tine legs and their associated drive mechanisms, as described above, will be provided side by side in the chassis 17. These mechanisms are operated at the same speed (they are driven off one gearbox), but will typically have their operating cycles offset such that the load on the drive components is distributed over the cycle and not subjected to the shock of all tines hitting the ground and being driven in simultaneously. This also reduces the force required to extract the tines from ground engagement and reduces the force created as the tines are driven into hard earth, which causes the chassis of the aerator to be lifted.

In a further embodiment, the rear guide mechanism may be replaced with a rosta tensioner arranged rearwardly of the tine leg 35. The rosta tensioner includes a torsion block, a tensioner arm extending from the torsion block and a roller which abuts the tine leg 35 substantially all of the time. The torsion block is preferably formed of a resilient material and is preferably mounted at one end to the frame 32.

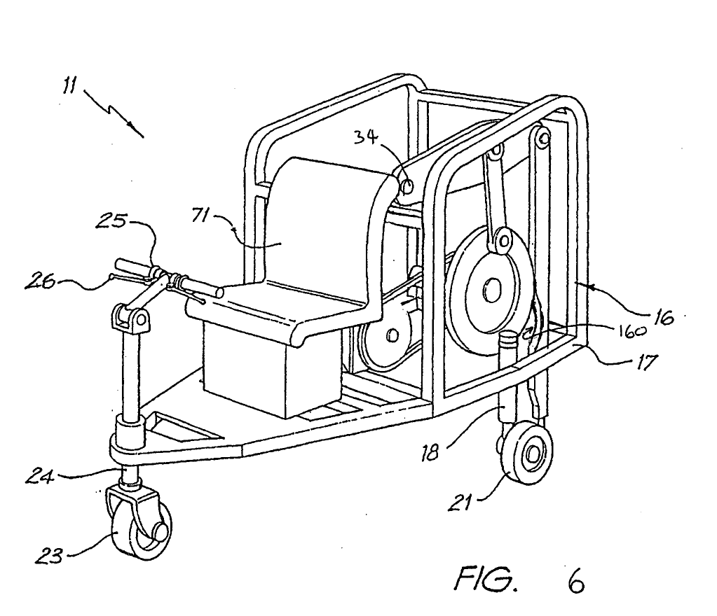

Turning to FIG. 5, a self propelled, “walk-behind” version of the aerator is illustrated. In this embodiment, again the aerator mechanism 16 is mounted on a chassis 17 and a ram 18 is resiliently connected to the chassis to carry the wheels or a roller 21. In this embodiment, the front of the implement is supported on a single or double wheel 23 mounted at the lower end of a post 24 rotatably mounted through the forward end of the chassis 17.

A control arm 25 extends from and is pivotally connected to the upper end of the post 24 and includes a plurality of control levers 26 used to operate the implement. A motor 27 is provided to drive the aerator mechanism and to propel the implement via the rear wheels 21.

Referring to FIG. 6, a “ride on” version of the aerator is illustrated, in which the forward end of the chassis 17 is elongated and an operator's seat 71 is provided behind the operating arm 25.

To avoid problems caused by lubricating oil, all of the pivot points and drive shaft bearings in the mechanisms are manufactured with self lubricating bushes formed of lubrication impregnated nylon and sealed bearings are used wherever required.

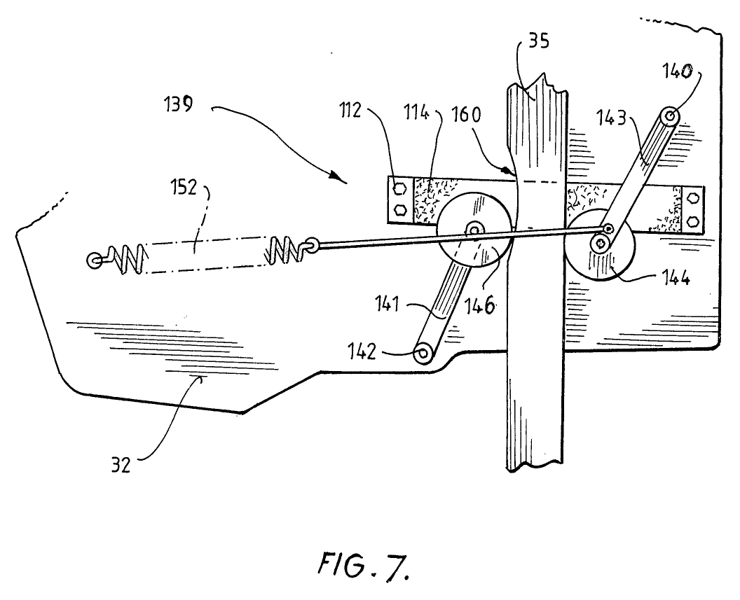

FIG. 7 illustrates the guide arrangement 139 as shown in FIG. 2. The guide arrangement is provided for guiding the lower end of the tine leg 35 and to ensure the required insertion into, and retraction from, the surface 52 of the green. The guide arrangement comprises a rear guide mechanism and a forward guide mechanism. The rear guide mechanism includes an arm 143, at the first end of which is a pivot 140 which is mounted to the frame 32. At a second end of the arm 143 is a rear-guide roller 144, which abuts the tine leg 35. Attached to the rear-guide roller 144 is a tension spring 152 which pulls the roller 144 forward (i.e. in the direction of travel) and accordingly biases the tine leg forward when not engaged in the ground.

The forward guide mechanism includes a spring arm 141 attached to the frame 32 at a mounting point 142. A forward travel-limiting stop roller 146 is attached to a distal end of the spring arm 141 such that the forward travel-limiting stop roller 146 limits the forward travel of the tine leg 35.

By adjusting the gearing in the gearbox of the aerator, the ground spacing of holes created by the tines 31 can be varied. For very rapid traversal of the turf 52, chatter of the tine legs 35 is inhibited by means of the spring-biased rollers 144 and the forward travel-limiting stop roller 146. The tine legs 35 are also constrained against lateral movement by means of a lined bracket 112 through which the tine leg 35 passes. The bracket 112 is slotted with a plastics lining 114 which is also self lubricating. For example, the lining 114 maybe PTFE.

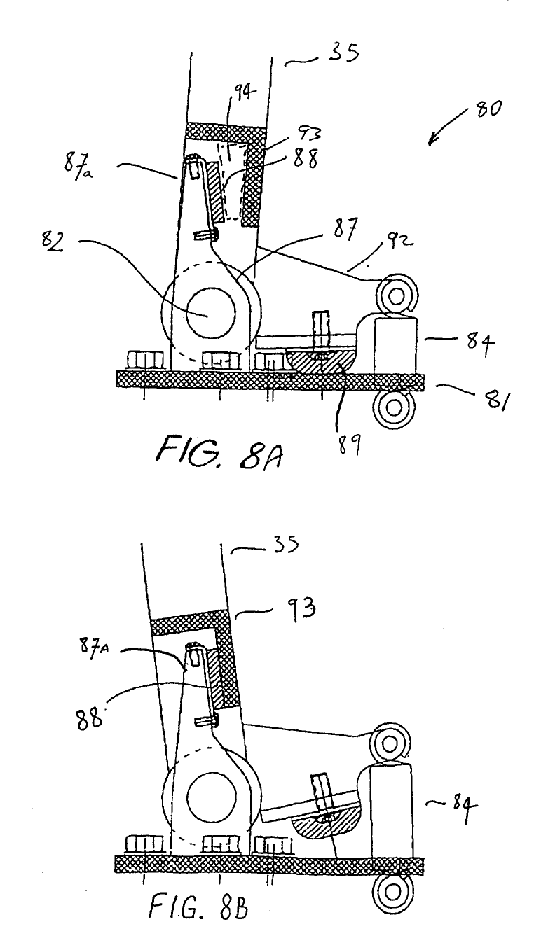

FIGS. 8A and 8B illustrate the foot assembly 80 as shown in FIG. 2. The foot assembly 80 is mounted to the tine leg 35.

Referring to FIG. 8A, the foot assembly 80, includes a first mounting member 87, and a second mounting member (not shown) which extend from a platform 81 and a tine leg 35 is pivotably connected between the first mounting member and the second mounting member. Each tine leg is connected to the mounting member by a pin 82.

An arm 92 extends from the tine leg 35. Stopper 89 is mounted on the arm 92 and rests against the platform 81 when the platform 81 is at a first end of its pivotal travel.

A spring 84 is mounted on the platform 81 behind (in the direction of movement of the aerator 11) the tine leg 35. The spring 84 is connected to an extremity of the arm 92.

FIG. 8B illustrates the foot assembly 80 when the spring 84 is extended. Second stoppers 88 are attached to a lip 87a of each mounting member. Angle brackets 93 are mounted on the tine leg 35. Second stoppers 88 stop against the angle brackets 93 when the tine leg 35 is at a second end of its pivotal travel.

The pivoting foot assembly 80 of FIGS. 8A and 8B, which carries the tine 31, is intended to rotate while the tine is in the ground allowing the tine to remain substantially vertical while the tine leg 35 swings through an arc. The foot pivots back to its original position under influence of the spring 84 when the tine leaves the ground.

Under some circumstances, it is desirable to restrict movement of the foot assembly 80 relative to the tine leg 35 such that the tine 31 pivots in the ground. To achieve this an optional wedge shaped block 94 may be clamped between the tine leg 35 and the angle bracket 93 to hold the foot assembly 80 at one end of its travel relative to the tine leg 35.

It will be appreciated by persons skilled in the art that numerous variations and/or modifications may be made to the turf aerator as shown in the specific embodiments without departing from the spirit or scope of the invention as broadly described. The present embodiments are, therefore, to be considered in all respects as illustrative and not restrictive.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A turf aerator with a reciprocating drive mechanism comprising:
a substantially rigid tine leg pivotally mounted at an upper end to a drive assembly arranged to reciprocate the tine leg along its longitudinal axis and the tine leg being provided with a cam surface facing the direction in which the aerator travels when in use,
the drive assembly comprising:
a reciprocating drive member to which the tine leg is pivotally attached at a first point along the drive member, the drive member being pivotally connected at a second point to a frame and at a third point to a first eccentric, the first eccentric being rotated to reciprocate the first point on the drive member substantially vertically; and
a forward guide arrangement comprising:
a forward travel-limiting stop acting on the cam surface of the tine leg to limit forward travel of the tine leg when the tine is out of the ground, the cam surface being shaped to compensate for arcuate motion of the first point of the drive member to thereby maintain a substantially straight and axial path of travel of the tine while the tine leg is running against the forward travel-limiting stop.

2. The turf aerator as claimed in claim 1 wherein, in use the tine remains substantially vertical and travels in a substantially vertical path while the tine leg is running against the forward travel-limiting stop.

3. The turf aerator as claimed in claim 1 wherein the cam surface has a shape which is a function of an arc of travel of the first point of the drive member.

4. The turf aerator as claimed in claim 1 wherein the forward travel-limiting stop comprises a roller mounted on a spring arm and located forward of the tine leg relative to the normal direction of travel of the aerator to define a forward limit of travel of the tine leg.

5. The turf aerator as claimed in claim 3 wherein the spring arm has a high spring rate causing it to be semi-rigid.

6. The turf aerator as claimed in claim 1 wherein the shape of the cam surface is adjusted to allow for the change in point of contact between the cam surface and the forward travel-limiting stop roller over the length of reciprocation of the tine leg.

7. The turf aerator as claimed in claim 1 wherein the third point of the reciprocating drive member is located intermediate the first and second points.

8. The turf aerator as claimed in claim 1 wherein the lower end of the tine leg is able to move in a rearward direction to allow the tine to move relative to the machine while the tine is in the ground.

9. The turf aerator as claimed in claim 1 wherein the tine leg is biased to a forward position such that when the tine leaves the ground, the tine leg returns toward the forward end of its travel ready for re-engagement with the ground.

10. The turf aerator as claimed in claim 9 wherein the forward biasing of the tine leg is achieved by a rear guide mechanism including a rear-guide roller mounted on a pivotable arm, located rearward of the tine leg relative to the normal direction of travel of the aerator and biased to a forward position.

11. The turf aerator as claimed in claim 10 wherein the rear-guide roller and the forward travel-limiting stop roller engage a lower portion of the tine leg whereby the rear-guide roller biases the tine leg towards a position ready for insertion of the tine into the ground and the forward travel-limiting stop roller limits travel of the tine leg in the forward direction.

12. The turf aerator as claimed in claim 9 wherein biasing of the tine leg towards a position ready for insertion of the tine into the ground is effected by way of a resiliently flexibly mounted guide arrangement.

13. The turf aerator as claimed in claim 12 wherein the guide arrangement comprises a roller mounted at the rear of the tine leg.

14. The turf aerator as claimed in claim 10 wherein the roller mounted at the rear of the tine leg is rotatably mounted at the end of a roller arm, and a plurality of coil spring are connected to the roller and/or its arm for drawing the roller into abutment with the tine leg and for exerting a restoring force on the tine leg.

15. The turf aerator as claimed in claim 12 wherein the guide arrangement also serves to damp rapid horizontal reciprocatory motion of the tine leg when the aerator is rapidly traversing a surface, in use.

16. A method of reciprocating a tine in a turf aerator comprising:
providing a substantially rigid tine leg carrying a substantially axially mounted tine at one end, and a cam surface on the tine leg facing the direction in which the aerator travels when in use:
driving the tine leg along its longitudinal axis the tine leg being pivotally mounted, at an end opposite the tine, to a drive assembly arranged to reciprocate the tine leg;
biasing the tine leg towards a forward travel-limiting stop acting on the cam surface of the tine leg to limit forward travel of the tine leg when the tine is out of the ground, the cam surface being shaped to compensate for arcuate motion of the pivotably connected end of the tine leg to thereby maintain a substantially straight and axial path of travel of the tine while the tine leg is running against the forward travel-limiting stop.

17. The method as claimed in claim 16 wherein, in use the tine is maintained substantially vertical and travels in a substantially vertical path while the tine leg is running against the forward travel-limiting stop.

18. The method as claimed in claim 16 wherein the cam surface is provided with a shape which is a function of an arc of travel of the first point of the drive member.

19. The method as claimed in claim 16 wherein the cam surface is provided with a shape adjusted to allow for the change in point of contact between the cam surface and the forward travel-limiting stop roller over the length of reciprocation of the tine leg.

20. The method as claimed in claim 16 wherein the lower end of the tine leg is permitted to move in a rearward direction to allow the tine to move relative to the machine while the tine is in the ground.
